(19) United States
(12) Patent Application Publication
(10) Pub. No.: US 2025/0105723 A1
(43) Pub. Date: Mar. 27, 2025

(54) Totem Pole, Zero Voltage Switching Power Factor Correction Operating At Constant Frequency

(71) Applicant: Rompower Technology Holdings, LLC, Milford, DE (US)

(72) Inventor: Ionel Jitaru, Tucson, AZ (US)

(73) Assignee: Rompower Technology Holdings, LLC, Milford, DE (US)

(21) Appl. No.: 18/974,660

(22) Filed: Dec. 9, 2024

Related U.S. Application Data
(63) Continuation-in-part of application No. 18/596,214, filed on Mar. 5, 2024.
Application No. 18/596,214 is a continuation of application No. 18/373,590, filed on Sep. 27, 2023, now Pat. No. 11,929,665.
Application No. 18/373,590 is a continuation-in-part of application No. 18/233,315, filed on Aug. 12, 2023.
Application No. 18/233,315 is a continuation of application No. 17/495,245, filed on Oct. 6, 2021, now Pat. No. 11,728,723.
Application No. 17/495,245 is a division of application No. 15/825,647, filed on Nov. 29, 2017, now Pat. No. 11,152,847.
Application No. 18/373,590 is a continuation-in-part of application No. 18/199,959, filed on May 21, 2023.
Application No. 18/199,959 is a continuation-in-part of application No. 17/495,170, filed on Oct. 6, 2021, now Pat. No. 11,671,027.
Application No. 17/495,170 is a continuation of application No. 16/751,747, filed on Jan. 24, 2020, now Pat. No. 11,165,360.
Application No. 16/751,747 is a continuation of application No. 16/503,432, filed on Jul. 3, 2019, now Pat. No. 10,574,148.
Application No. 18/373,590 is a continuation-in-part of application No. 63/377,229, filed on Sep. 27, 2022.
(60) Provisional application No. 63/578,130, filed on Aug. 22, 2023.
(60) Provisional application No. 62/429,373, filed on Dec. 2, 2016.
(60) Provisional application No. 63/608,019, filed on Dec. 8, 2023.

(51) Int. Cl. H02M 1/08; H01F 38/42; H02M 1/00; H02M 1/34; H02M 1/42; H02M 3/155; H02M 3/335

(52) U.S. Cl. CPC H02M 1/083; H02M 1/4258; H02M 3/155; H02M 3/335; H02M 3/33553; H02M 3/33592; H01F 38/42; H02M 1/0058; H02M 1/342; Y02B 70/10

(57) ABSTRACT

This specification presents a boost topology operating in discontinuous mode wherein the energy contained in the parasitic oscillations is harvested and used to obtain zero voltage switching in any operating conditions. This boost topology is further used in power factor correction application wherein the operation frequency can be maintained in a very narrow range of operation.

### CROSS-REFERENCE TO RELATED APPLICATIONS

This application claims the benefit of U.S. Provisional Application No. 63/608,019, filed Dec. 8, 2023. This application is also a continuation-in-part of and claims the benefit of prior U.S. patent application Ser. No. 18/596,214, filed Mar. 5, 2024, which is a continuation of and claims the benefit of prior U.S. patent application Ser. No. 18/373,590 filed Sep. 27, 2023. Said prior U.S. patent application Ser. No. 18/373,590 is a continuation in part of and claims the benefit of prior U.S. patent application Ser. No. 18/233,315 filed Aug. 12, 2023, is a continuation in part of and claims the benefit of prior U.S. patent application Ser. No. 18/199,959 filed May 21, 2023, claims the benefit of prior U.S. Provisional Application No. 63/377,229 filed Sep. 27, 2022, and claims the benefit of prior U.S. Provisional Application No. 63/578,130 filed Aug. 22, 2023. All of the above-identified applications are hereby incorporated by reference in their entireties.

### FIELD

The present specification relates generally to electronics, and more particularly to topologies used in power converters.

### BACKGROUND

A traditional method for power factor correction was to use a boost topology operating in discontinuous mode and the use of valley detection wherein the main switch turned on the valley to minimize the switching losses. This solution was good for low frequency operation only, though; at high input voltage the valley voltage was not as low and generated considerable switching losses. At higher operation frequency, the switching on the valley of the parasitic oscillations is not suitable anymore.

### SUMMARY

A boost converter includes an input voltage source, an inductive element having a primary winding and a secondary winding, a power switch connected to a termination of the primary winding, a first rectifier having an anode and a cathode, wherein the anode is connected to the termination of the primary winding, and the cathode is connected to an output capacitor, an output load connected across the output capacitor, a current injection circuit formed by a current injection switch connected to a first termination of the secondary winding, a current injection capacitor connected to a second termination of the secondary winding, a current injection diode connected to the second termination of the secondary winding, a storage capacitor connected to the anode of said current injection winding, a storage capacitor connected to an anode of the current injection diode, a slew rate capacitor connected to the anode of the first rectifier and to a node, wherein the node is connected to first and second signal rectifiers, the first signal rectifier has an anode connected to the slew rate capacitor and a cathode connected to the storage capacitor, and the second signal rectifier has a cathode connected to the slew rate capacitor.

The above provides the reader with a very brief summary of some embodiments described below. Simplifications and omissions are made, and the summary is not intended to limit or define in any way the disclosure. Rather, this brief summary merely introduces the reader to some aspects of some embodiments in preparation for the detailed description that follows.

### BRIEF DESCRIPTION OF THE DRAWINGS

Referring to the drawings:

FIG. 1A depicts a classical boost topology;

FIG. 1B depicts waveforms of the topology from FIG. 1A;

FIG. 1C depicts a boost topology using current injection;

FIG. 1D depicts waveforms of the topology from FIG. 1C;

FIG. 1F depicts a ZVS boost topology using current injection and additional energy injection harvested from dV/dt on the switching node;

FIG. 1J depicts waveforms from the circuit depicted in FIG. 1F;

FIG. 2A depicts a boost topology wherein parasitic oscillation energy is harvested;

FIG. 2B depicts waveforms of the topology depicted in FIG. 2A;

FIG. 3A presents a module, ASSM;

FIG. 3B presents the block of the module from FIG. 3A;

FIG. 4A presents a boost topology using the ASSM module from FIGS. 3A and 3B;

FIG. 4B presents the boost topology using the ASSM module placed on a coupling winding;

FIG. 4C presents waveforms of the circuit from FIGS. 4A and 4B;

FIG. 4D presents the shorting switch module SSM used in the circuit from FIG. 2A;

FIG. 4E presents the HESSM module;

FIG. 4F presents the MCPM module;

FIG. 4I presents the HESSM module placed in the secondary of a flyback topology;

FIG. 5 presents the totem pole bridgeless PFC circuit;

FIG. 6 presents the frequency variation in a totem pole with critical conduction mode Power Factor Correction Topology;

FIG. 7 presents the totem pole Power Factor Correction Topology using MCPM module;

FIG. 7A presents the totem pole Power Factor Correction Topology using MCPM module from t0 to t1;

FIG. 7B presents waveforms of a totem pole Power Factor Correction Topology using MCPM module from t0 to t1;

FIG. 7C presents the current through Lc and input AC line current in a totem pole Power Factor Correction Topology using MCPM module from t0 to t1;

FIG. 8A presents the totem pole Power Factor Correction Topology using MCPM module from t1 to t2;

FIG. 8B presents waveforms of a totem pole Power Factor Correction Topology using MCPM module from t1 to t2;

FIG. 8C presents the current through Lc and input AC line current in a totem pole Power Factor Correction Topology using MCPM module from t1 to t2;

FIG. 9A presents the totem pole Power Factor Correction Topology using MCPM module from t2 to t3;

FIG. 9B presents waveforms of a totem pole Power Factor Correction Topology using MCPM module from t2 to t3;

FIG. 9C presents the current through Lc and input AC line current in a totem pole Power Factor Correction Topology using MCPM module from t2 to t3;

FIG. 10A presents the totem pole Power Factor Correction Topology using MCPM module from t3 to t4;

FIG. 10B presents waveforms of a totem pole Power Factor Correction Topology using MCPM module from t3 to t4;

FIG. 10C presents the current through Lc and input AC line current in a totem pole Power Factor Correction Topology using MCPM module from t3 to t4;

FIG. 11A presents the totem pole Power Factor Correction Topology using MCPM module from t0 to t1 for a negative polarity of the AC line;

FIG. 11B presents waveforms of a totem pole Power Factor Correction Topology using MCPM module from t0 to t1 for a negative polarity of the AC line;

FIG. 11C presents the current through Lc and input AC line current in a totem pole Power Factor Correction Topology using MCPM module from t0 to t1 for a negative polarity of the AC line;

FIG. 12A presents the totem pole Power Factor Correction Topology using MCPM module from t1 to t2 for a negative polarity of the AC line;

FIG. 12B presents waveforms of a totem pole Power Factor Correction Topology using MCPM module from t1 to t2 for a negative polarity of the AC line;

FIG. 12C presents the current through Lc and input AC line current in a totem pole Power Factor Correction Topology using MCPM module from t1 to t2 for a negative polarity of the AC line;

FIG. 13A presents the totem pole Power Factor Correction Topology using MCPM module from t2 to t3 for a negative polarity of the AC line;

FIG. 13B presents waveforms of a totem pole Power Factor Correction Topology using MCPM module from t2 to t3 for a negative polarity of the AC line;

FIG. 13C presents the current through Lc and input AC line current in a totem pole Power Factor Correction Topology using MCPM module from t2 to t3 for a negative polarity of the AC line;

FIG. 14A presents the totem pole Power Factor Correction Topology using MCPM module from t3 to t4 for a negative polarity of the AC line;

FIG. 14B presents waveforms of a totem pole Power Factor Correction Topology using MCPM module from t3 to t4 for a negative polarity of the AC line;

FIG. 14C presents the current through Lc and input AC line current in a totem pole Power Factor Correction Topology using MCPM module from t3 to t4 for a negative polarity of the AC line; and

FIG. 15 presents a totem pole Power Factor Correction Topology using MCPM module and current injection topology.

### DETAILED DESCRIPTION

Reference now is made to the drawings, in which the same reference characters are used throughout the different figures to designate the same elements. Briefly, the embodiments presented herein are preferred exemplary embodiments and are not intended to limit the scope, applicability, or configuration of all possible embodiments, but rather to provide an enabling description for all possible embodiments within the scope and spirit of the specification. Description of these preferred embodiments is generally made with the use of verbs such as “is” and “are” rather than “may,” “could,” “includes,” “comprises,” and the like, because the description is made with reference to the drawings presented. One having ordinary skill in the art will understand that changes may be made in the structure, arrangement, number, and function of elements and features without departing from the scope and spirit of the specification. Further, the description may omit certain information which is readily known to one having ordinary skill in the art to prevent crowding the description with detail which is not necessary for enablement. Indeed, the diction used herein is meant to be readable and informational rather than to delineate and limit the specification; therefore, the scope and spirit of the specification should not be limited by the following description and its language choices.

This specification presents a Power Factor Correction circuit using a ZVS (Zero Voltage Switching) boost topology.

Zero voltage switching is obtained from harvesting the energy from parasitic oscillation, and in some application additional energy is injected as presented in U.S. Pat. No. 11,929,665, to which a benefit claim is made.

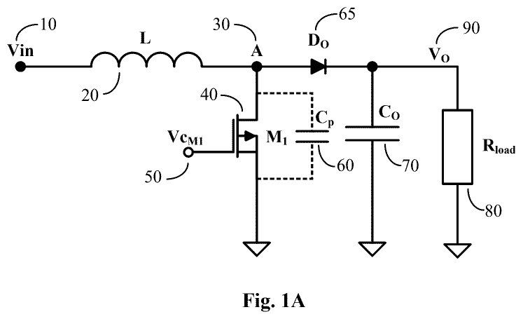

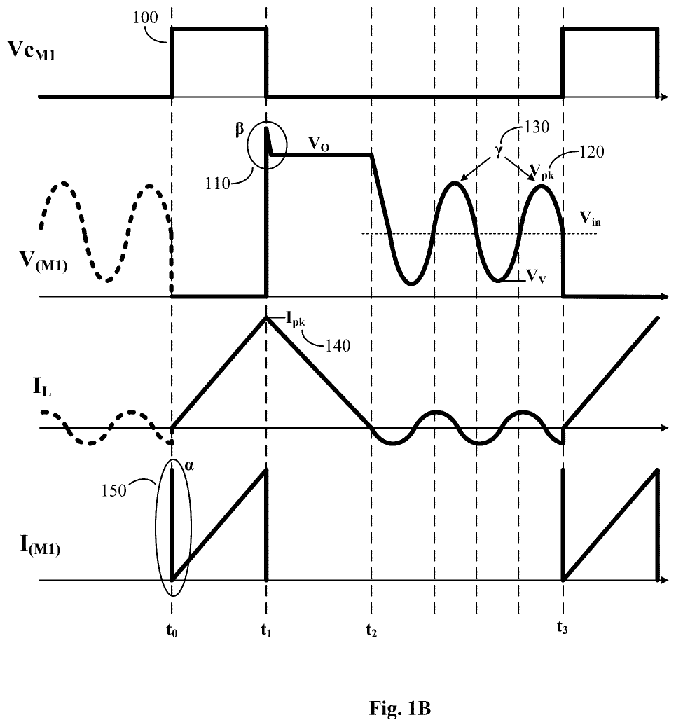

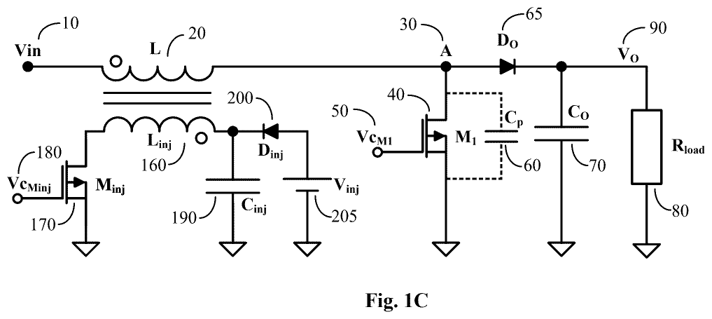

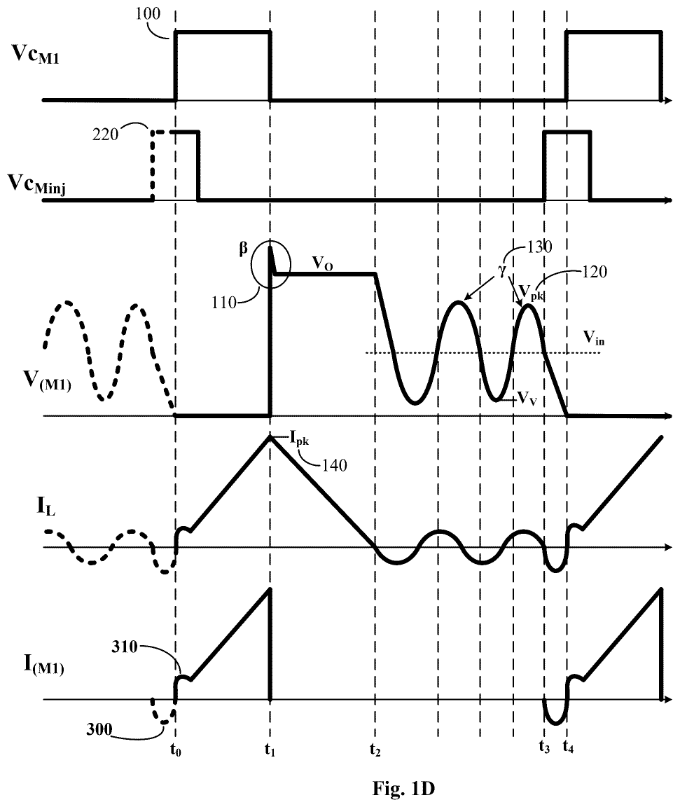

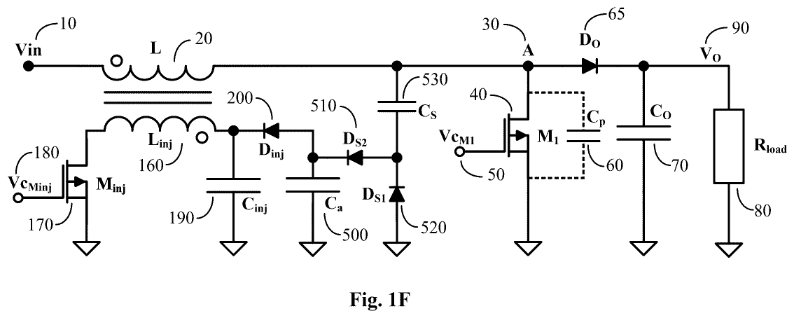

In FIG. 1A, a basic configuration of the boost topology is presented. This is formed by an inductive element L, 20, a main switch M1, 40, an output diode Do, 65, an output capacitor Co, 70, and an output load Rload, 80. A parasitic capacitance Cp, 60, is connected across the M1. The parasitic capacitance represents all the parasitic capacitances reflected across the main switch M1. The parasitic capacitance Cp represents the parasitic capacitance across L, across Do, and also the parasitic capacitance of the PCB layout which reflects across M1.

FIG. 1B depicts waveforms associated with the circuit from FIG. 1A. The waveforms are the control signal VcM1 of the main switch, M1, the voltage across M1, V(M1), the magnetizing current IL, and the current I(M1) through the main switch M1. The boost topology has several drawbacks which are underlined by the marked areas such as “α”, “β”, “ [symbol] ” and “σ”.

At t0, the main switch M1 turns on when the voltage across M1 was at a given level, and the turns on is done in a hard switching mode by discharging the capacitor Cp, which was charged at said level. The discharge of Cp leads to a current spike depicted by the area “α”, 150. That leads to switching losses in addition to the noise which will be coupled to the rest of the circuit. Between t0 to t1 the current builds up via the inductor element L, 20.

At t1, the main switch M1 turns off and the current flowing through L further starts flowing visa Do, 65. The large dV/dt via Do, wherein current ramps from zero to the Ipk, 140, the rectifier means, diode or a synchronous rectifier will not open instantaneously and there will be a forward recovery time which will create a voltage spike in the switching node A. That is depicted by the marker “β”, 110.

Between t1 and t2, the magnetizing current via L further flows via Do to Vo. The magnetizing current flowing via Do decays towards zero reaching zero amplitude at t2.

Between t2 and t3—also referred to as dead time—the parasitic oscillation will occur, parasitic oscillation formed by the resonant circuit formed by Cp and L.

The parasitic oscillations are marked by “ [symbol] ”, 130. The parasitic oscillations lead to dissipation in conduction via L, and also in the magnetic core on which the winding is wound.

FIG. 1C shows a solution to obtain zero voltage switching in the boost topology and also eliminate the overshoot in the switching node of the boost topology with the use of Rompower current injection. In addition to the basic structure of the boost topology depicted in FIG. 1A, there is an additional circuit formed an auxiliary winding Linj wound on the same magnetic core as L, a current injection switch Minj, a current injection capacitor Cinj, a diode Dinj and a voltage source Vinj.

The role of the Vinj source is to provide additional energy for the current injection. The Vinj can be generated by an additional winding wound on the magnetic core of L and a rectifier diode and a storage capacitor, though the best way to generate Vin is to extract it from the parasitic elements. The current injection method is presented in U.S. Pat. No. 10,574,148 entitled “Self-adjusting current injection technology”, which is referred to in this patent as “Rompower current injection.”

FIG. 1D depicts waveforms from the circuit as presented in FIG. 1C. The waveforms are: VcM1, 210, VcMinj, 220, V(A) and the current through L, I(L) and the current through M1, I(M1).

Between t0 to t1, M1 turns on and the current starts flowing from Vin via L and M1. The slope of this current is Vin/L and reaches its peak at t1.

In between t1 to t2 the current through L, IL, starts decaying with a slope (Vo−Vin)/L, until reaches zero at t2. In between t2 to t3, referred also as the dead time period, parasitic oscillations do occur.

At t3, the current injection switch Minj is turned on. A current injection pulse is generated by the energy stored in Cinj and additional energy from Vinj. This pulse of current of sinusoidal shape starts flowing via the leakage inductance between Linj and L, and the current injection pulse is reflected in L flowing with the polarity towards Vin. The current injection reflected in L starts discharging the parasitic capacitance Cp reflected across M, towards zero as depicted in V(M1) from FIG. 1D. The current injection reflected in L is depicted by the IL and I(M1) from FIG. 1D.

To minimize the energy processed by the current injection circuit, the activation of the current injection is done on the valley of the parasitic oscillations ( [symbol] ) from FIG. 1D. Rompower current injection is self-adjusting. The amplitude of the current injection is self-adjusting function of the voltage in the switching node A. For a larger voltage in A at the time when current injection switch Minj, is turned on, the current injection current amplitude is larger and for a lower voltage in A at the time when the current injection is turned on, the current injection amplitude is lower.

The self-adjusting feature of the current injection minimizes the energy consumption in discharging a capacitor reflected in the switching node A. Rompower current injection technology eliminates the hard switching drawback of the boost converter exemplified by “α”.

Another drawback of the boost topology is the forward recovery time of the output rectifier Do which leads to the voltage overshoot in A, depicted by in FIG. 1A by “β”, 110.

To reduce the overshot in A when the main switch M1 turns on, FIG. 1F presents an embodiment of this disclosure. To reduce the dV/dt at turn off, a capacitor Cs, 530, is placed in the switching node A. The capacitor Cs is placed in series with a circuit formed by two diodes, Ds1, 520, and Ds2, 530, and a capacitor Ca as depicted in FIG. 1F. The current flowing through Cs which reduced the dV/dt in A is charging the capacitor Ca, 500. The energy stored in Ca is further extracted by the current injection circuit via Dinj. The presence of Cs in the switching node A increases the capacitance reflected in A which requires more energy to discharge the capacitances reflected in A such as Cp plus Cs. However, the energy injected in Cs at t1 when M1 turns off is further used by the current injection circuit to discharge Cs+Cp before the M1 turns on.

This feature of the current injection includes extraction of energy from parasitic elements including the energy from Cs and use that energy to energize the current injection and create zero voltage switching conditions for M1.

FIG. 1J presents waveforms presented in FIG. 1D plus the current injection current I(Minj), 540, and the voltage across Ca, 550.

As presented in FIG. 1J from t1 to t1′ the slew rate of the voltage in A is decreased as depicted by V(M1) and during this time interval (t1-t1′) the voltage in A increases from 0 to Vo. The slow dV/dt allows the output rectifier to turn on and in this way the overshoot “β” is eliminated.

The circuit presented in FIG. 1F, which is an embodiment of this invention, underlines another feature of the current injection circuit, that of energy extraction from storage capacitors such as Ca and use that energy to create zero voltage switching conditions for M1. The circuit formed by Cs, Ds1 and Ds2 has the function of a snubber and in combination with current injection this snubber becomes a lossless snubber.

This feature of Rompower current injection is named the “lossless snubber” feature of the current injection circuit, wherein energy extracted from parasitic elements is stored in a capacitor and is further extracted by the current injection circuit and used to create zero voltage switching conditions for the main switch.

Energy Extraction from the Parasitic Oscillations in Boost Topology

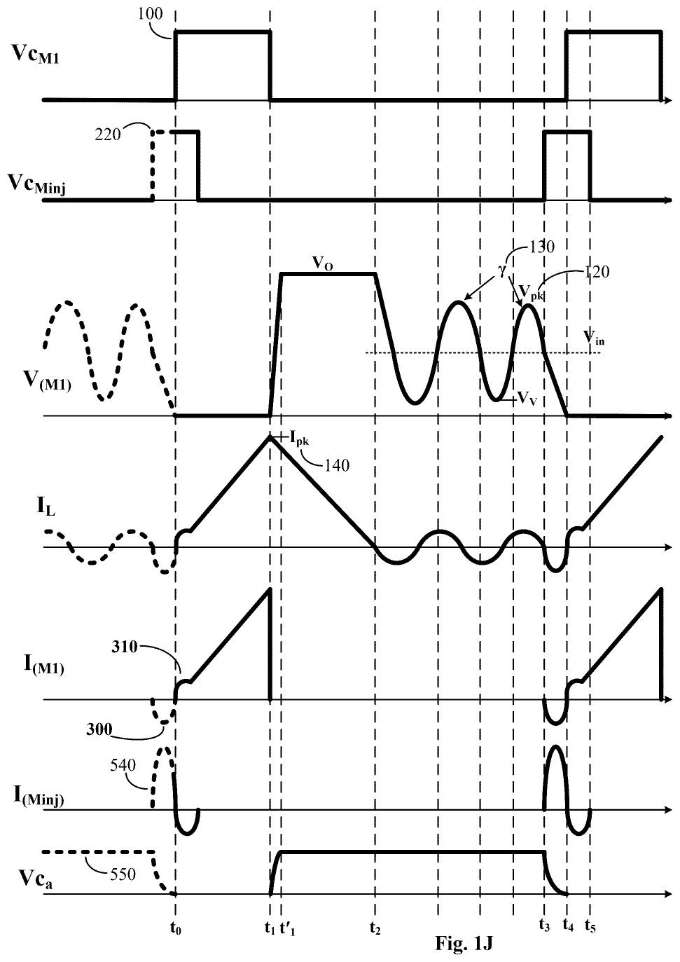

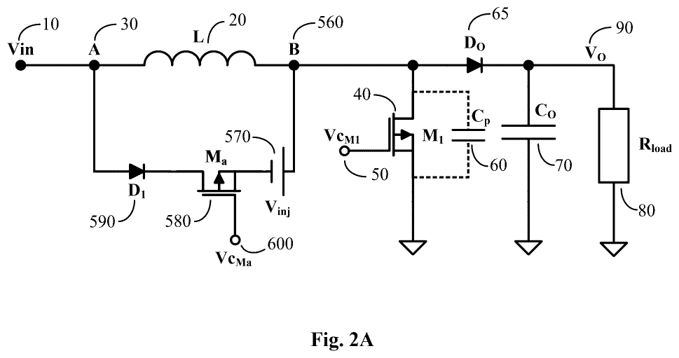

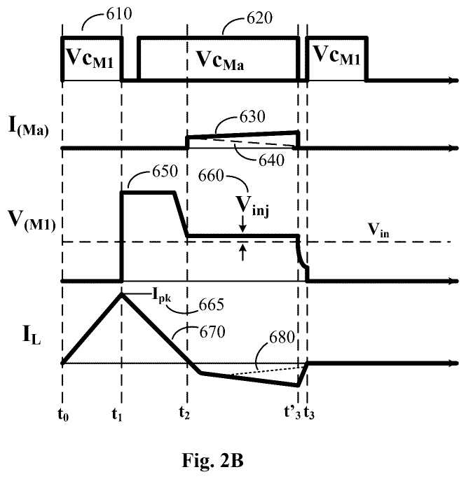

Another embodiment of this invention is harvesting the energy from parasitic oscillation, as depicted in FIG. 2A.

The waveforms are depicted in FIG. 2B. The waveforms presented are: the control of M1, VcM1, the control of Ma, 600, the current via Ma, I(Ma), the voltage across M1, V(M1) and the current through L, IL.

The main switch M1, turns on at t0 and turns off at t1. In between t0 to t1 the current builds up through L reaching its peak Ipk, 665, at t1.

In between t1 to t2 the current starts to decay from its peak Ipk, 665, to 0 reaching 0 amplitude at t2. In between t1 to t1 all the energy stored in L is transferred to the Co in parallel with Rload.

Between t1 and t2, the shorting switch Ma is turned on, in such way that at t2 when the current through L reaches zero, Ma is already on and the negative magnetizing current energized by the energy contained in Cp when the voltage varies from Vo to Vin.

Between t2 and t3′, the magnetizing current flows via the unidirectional shorting switch formed by D1 and Ma. In the event Vinj is zero the negative magnetizing current depicted by I(Ma) decays as depicted by the dotted line, 640. The presence of Vinj increases the amplitude of I(Ma) as depicted by I(Ma), 630.

The Vinj voltage which is connected in series with the unidirectional switch is visible also on the voltage across V(M1) in between t2 to t3′, wherein the voltage is above Vo by Vinj.

At t3′, the auxiliary switch Ma turns off and the negative magnetizing current flowing through L, depicted in IL, starts decaying towards zero and discharging in the process the parasitic capacitance Cp, across the main switch M1. If the amplitude of negative magnetizing current at t3′ has the proper amplitude the parasitic capacitance Cp reaches zero prior t3 when the main switch M1 turns on, creating zero voltage switching conditions for M1.

In order to ensure that at t3′ the negative magnetizing current has the proper amplitude Vinj has to be tailored accordingly function of Vin and the time interval in between t2 to t3′. A larger amplitude Vinj increases the amplitude of the negative magnetizing current to ensure more than necessary amplitude of IL at t3′ to discharge the parasitic capacitance Cp to zero prior t3. The side effect of this method is that increases the RMS current via Ma and D1 and increase in this way the conduction losses.

One method to avoid unnecessary power dissipation in the shorting switch is by having a variable Vinj. Vinj can be kept at low amplitude, such as zero amplitude and increase the Vinj amplitude prior t3′.

By controlling the time interval in between t3′ and the time when Vinj amplitude increases the amplitude of the negative magnetizing current, the peak negative magnetizing current at t3′ can be controlled to discharge Cp to zero prior t3 when M1 turns on.

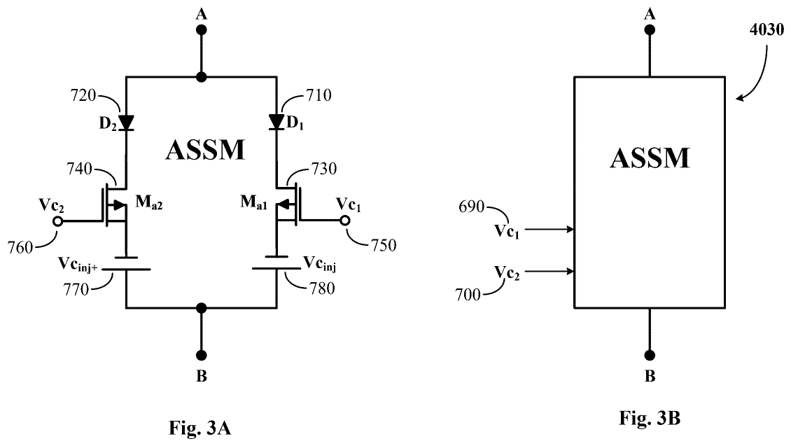

FIG. 3A depicts a configuration for the shorting switch wherein the amplitude of Vinj is controlled. In this circuit there are two legs with two shorting switchers, one formed by D1 and Ma1 controlled by Vc1 and with a voltage injection Vinj. The second leg formed by D2 and Ma2 controlled by Vc2 and with a voltage injection Vinj+. By design Vinj+>Vinj. This module further depicted in FIG. 3B as a module 4030, ASSM, (Adjustable Shorting Switch Module).

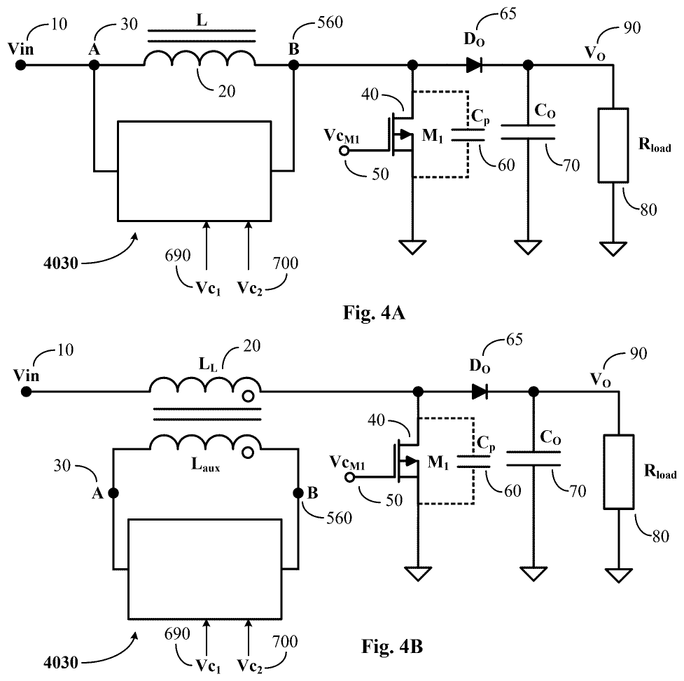

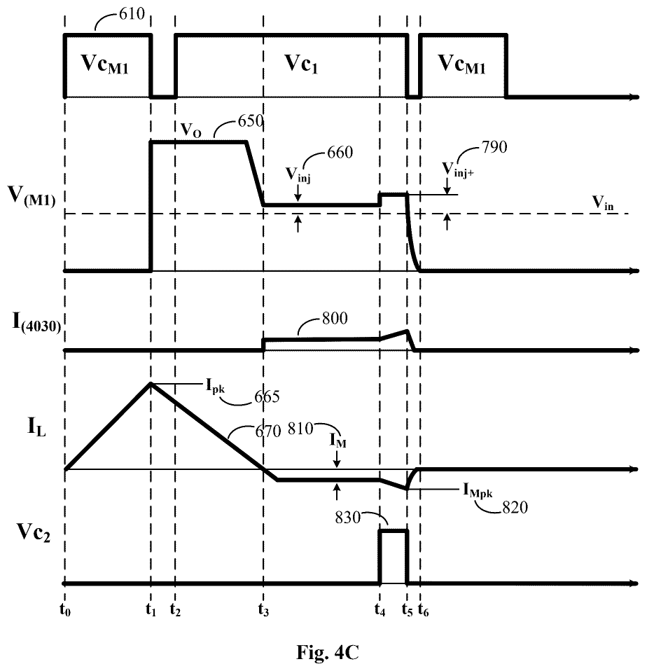

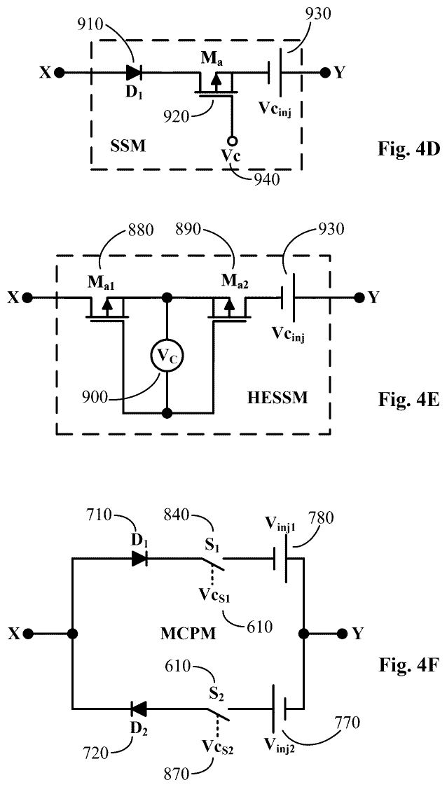

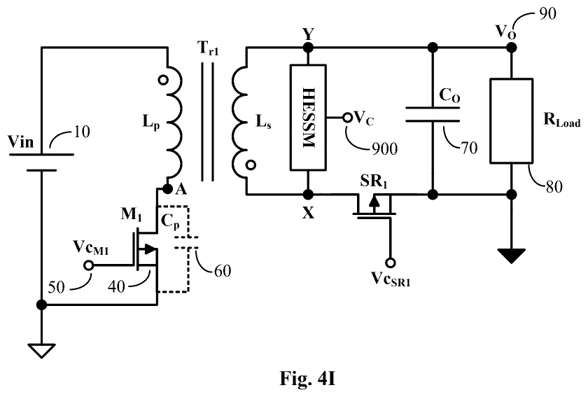

FIG. 4A presents a boost topology wherein a the Adjustable Vinj module 4030 is placed across L. FIG. 4B depicts a boost topology wherein the Adjustable Vinj module, 4030, also named ASSM (Adjustable Shorting Switch Module) is placed across an auxiliary winding which is wound on the same magnetic core on which L is wounded wherein L and Laux is very well coupled.

FIG. 4C depicts waveforms associated with the circuits depicted in FIGS. 4A and 4B. The waveforms are control signals for M1 and Ma1, which is VcM1 and Vc1, the voltage across M1, V(M1), the current via Adjustable Vinj module, 4030, I(4030), the magnetizing current via the magnetic element L, IL, and the Vc2.

Between t0 and t1, M1 is turned on and the current starts flowing through L from zero to Ipk. During this time energy is stored in L in the form of magnetic energy. The following cycle is in between t2 and t3. During this time interval the energy stored in L in between t0 and t1 is transferred to Co and Rload. In between t1 and t3, at t2 Vc1 becomes high to turn on Ma1.

At t3 the magnetizing current through L reached zero and further the voltage across M1 starts decaying form Vo level to Vin level time period wherein the electrical energy stored in Cp is transformed in magnetic energy which is stored in the negative magnetizing current IM which circulates via Ma1.

At t4, Vc2 is high and turns on Ma2, and Vinj+ is applied across L and that is visible on V(M1). During this time the current through L builds up with a higher dI/dt to reach the level IMpk, 820. By controlling the time interval between t4 and t5, the amplitude of the negative magnetizing current is controlled. The goal is for IMpk to have the necessary amplitude to discharge Cp to zero in between t5 to t6.

In this method, the Vinj+ remains constant and only the time interval t4 to t5 is controlled which can be easily done in digital control.

For simplicity Vinj=0 and Vinj+ is constant and t4 to t5 is controlled to discharge the Cp to a predetermined level which in most applications is zero. Using this technology the energy contained in the parasitic oscillations is harvested and additional energy is injected from Vin+ in between t4 and t5 in order to discharge Cp in between t4 and t5.

For a higher Vin, the Vinj+ has to be higher in order to increase IM to the necessary level to discharge the parasitic capacitance Cp. A good solution is to have Vinj+ proportional with Vin. By having Vinj proportional to Vin, the time interval between t4 to t5 can be contained in a narrow interval.

The unidirectional shorting switch depicted in FIG. 2A is composed by a diode D1 in series with a controlled mosfet Ma. In some applications wherein the magnetizing current is large this solution may not be as efficient due to the voltage drop on the diode D1. FIG. 4D presented the Shorting Switch Module (SSM) which has two power terminations X and Y and a control termination wherein Vc is applied.

In applications in which the current flowing through the shorting switch model is high, say, larger than 300 mA, the shorting switch is replaced by two mosfets with common source and without the diode. This module is named High Efficiency Shorting Switch (HESSM).

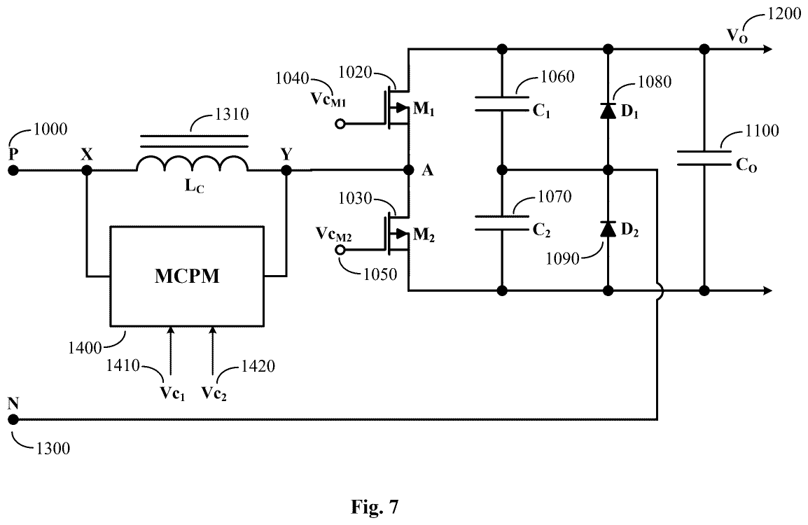

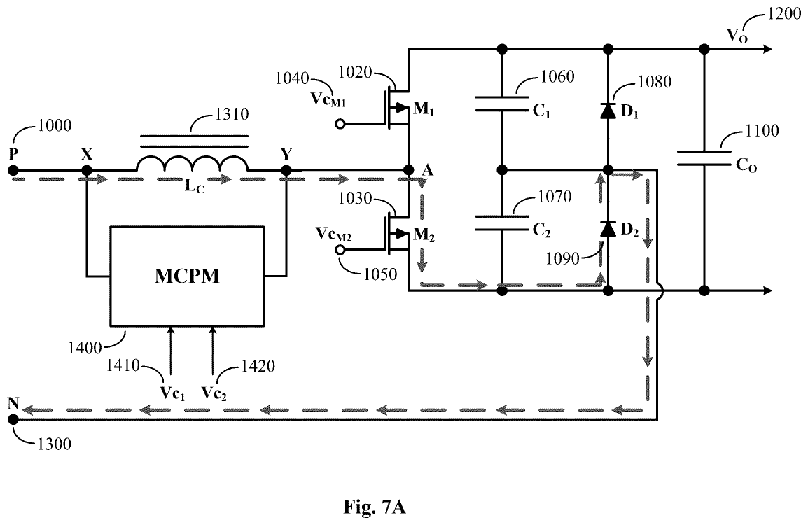

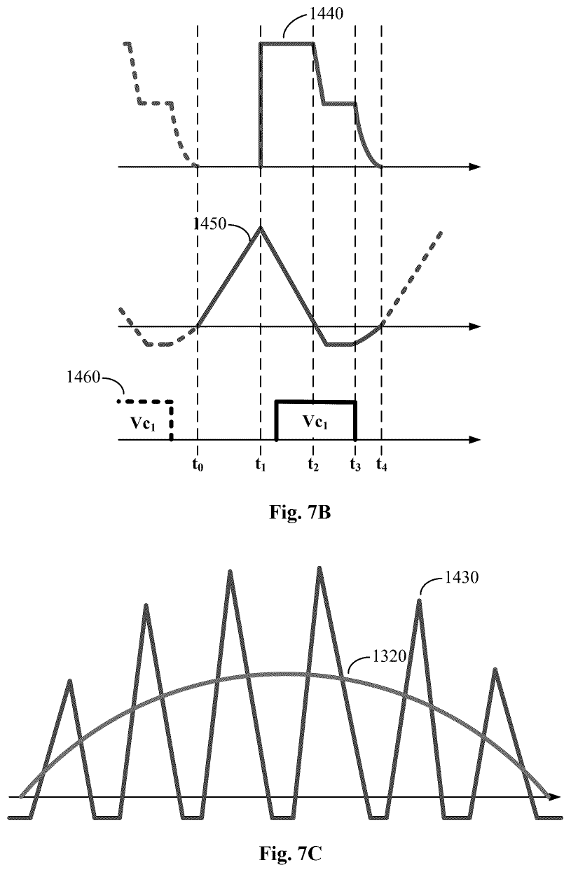

Another module MCPM (Magnetizing Current Preservation Module). The MCPM is depicted in FIG. 4F. The MCPM depicted in FIG. 4F continues two shorting switchers which allow the current flow for two different polarities. The first branch of the MCPM allows the current flow via D1, S1 and Vinj, and the second branch the current flow is in opposite direction from Y to X via D2, S2 and Vinj2. This circuit is designed to accommodate inductive elements wherein the current flow in both directions as is the case of Lc from FIG. 7.

Another application for the MCPM is in the Power Factor correction circuits that are designed to shape the input current extracted from a AC input voltage source in the same sinusoidal shape of the input voltage line.

The preferable topology for shaping the input current into a sinusoidal shape is the boost topology.

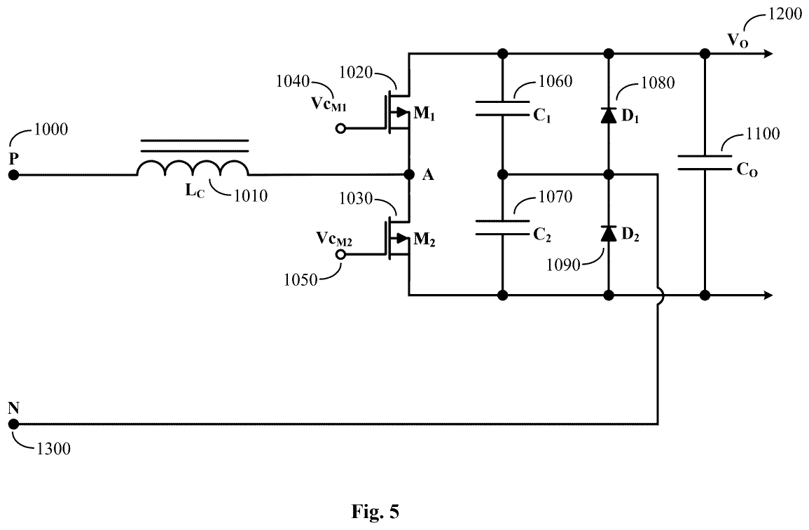

One of the most efficient structures for the power factor correction circuit is depicted in FIG. 5. It is formed by a totem pole structure formed by M1, 1020, and M2, 1030, and inductive element Lc, 1010, and a semi bridge formed by D1, 1080, and D2, 1090, and two capacitors C1, 1060, and C2, 1070. D1 and D2 form a low frequency semi bridge because the conduction through D1 and D2 have a low frequency, the same as the line frequency. The D1 and D2 can be easily replaced with two synchronous rectifiers to reduce the conduction losses and improve the efficiency. Lc, 1010, represents the inductive element in a boost topology.

The input bridge generally contains four rectifiers and, in the structure, depicted in FIG. 5 there are only two input rectifiers, and the rectification of the AC line is done properly and for this reason this topology is named “bridgeless PFC” though it is not fully bridgeless. M1 and M2 from FIG. 5 form a semi bridge, but the function is to operate as a boost converter and the operation frequency is much higher than D1 and D2.

One of the most popular prior art implementations of the totem pole bridgeless PFC is the operation of the boost topology in critical conduction wherein the switching elements M1 and M2 turn on at zero voltage switching conditions. There are several drawbacks of this technology such as large peak currents and a large variation of the operation frequency for the purpose to operate in critical conduction mode.

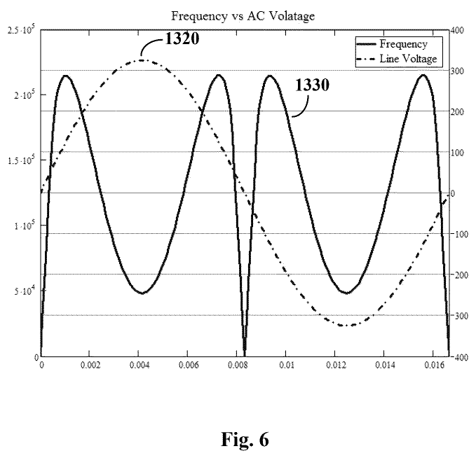

FIG. 6 depicts the input AC input voltage and the frequency of operation. As is presented the frequency of operation reaches very high levels (220 Khz) for low amplitude level of the AC input line voltage and very low frequency of operation (35 Khz) for the peak input voltage. This means a 6:1 frequency range for the AC line varying from zero to the peak level. With such a large frequency swing the optimization of the input EMI filter becomes a challenge.

### Power Factor Correction Circuit Using a Totem Pole, Bridgeless Topology and a Boost Topology Operating in Discontinuous Mode

In the previous art the ZVS totem pole bridgeless PFC used a conduction operation for the boost topology. As mentioned, there are several drawbacks of this solution such as very large peak currents, and a large variation of the frequency of operation as depicted in FIG. 6. The goal is to operate in a much narrow frequency swing, ideally constant frequency in order to optimize the input EMI filter.

FIG. 7 presents the totem pole bridgeless PFC wherein the operation is done in discontinuous mode, even operating at constant frequency. In the circuit from FIG. 7 there is a module MCPM (Magnetizing Current Preservation Module). The MCPM is depicted in FIG. 4F. The MCPM in FIG. 4F contains two shorting switchers which allow the current flow for two different polarities. The first branch of the MCPM allows the current flow via D1, 710, S1, 840, and Vinj1, 780, and the second branch the current flow is in opposite direction from Y to X via D2, 720, S2, 850, and Vinj2, 770. This circuit is designed to accommodate inductive elements wherein the current flow in both directions as is the case of Lc from FIG. 7.

Between t0 and t1 as depicted in FIGS. 7A and 7B and 7C, the switch M2 is turned on and the current flows from P (Phase) via Lc, and M2 and further through D2 back to N (neutral). During this time interval the current builds up via Lc, storing energy in Lc.

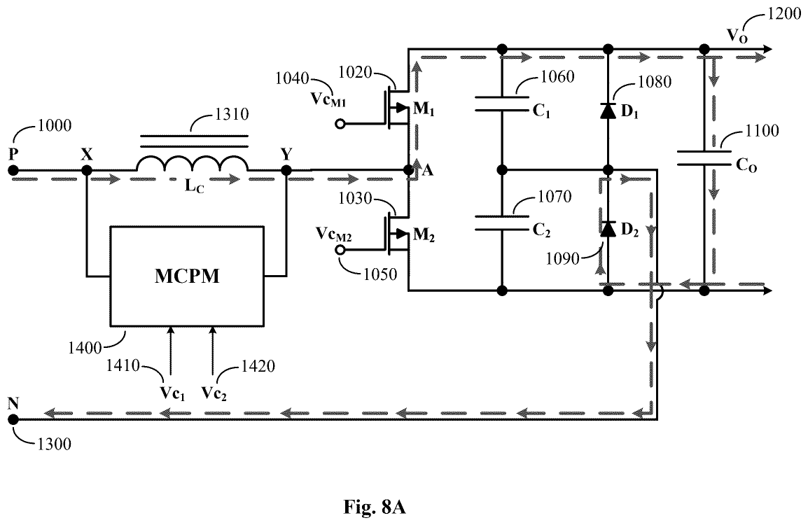

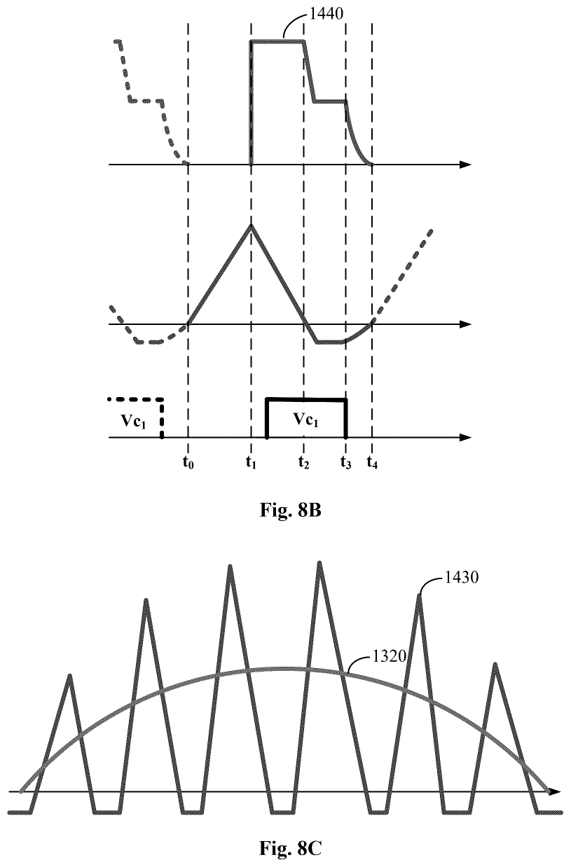

Between t1 and t2 as depicted in FIGS. 8A and 8B and 8C, the switch M2 is turned off and the current through Lc continues to flow via M1 and M1 is turned on. The current continues to flow towards output charging the capacitor Co and further via D2 towards the N (Neutral). In FIG. 8B is depicted the voltage in the switching node A, and the current through Lc. In between t1 to t2 the current decays form its peak to zero transferring the energy stored in Lc during t0 to t1 and this energy is delivered to Co and the load connected across Co.

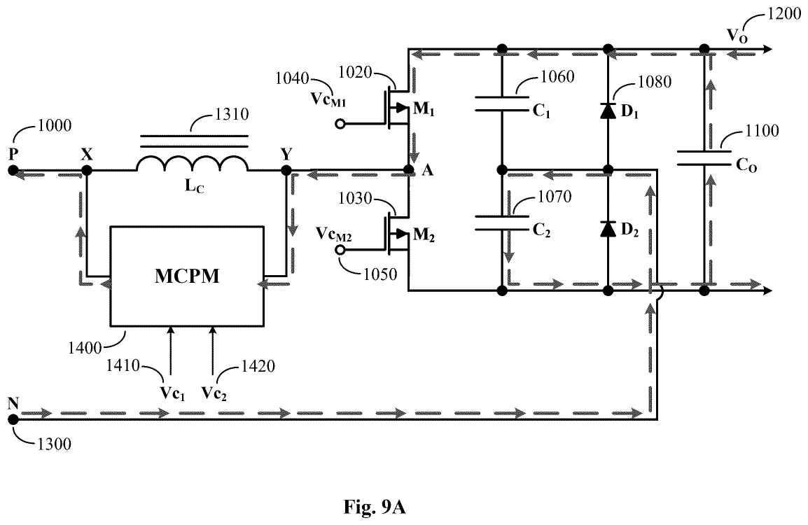

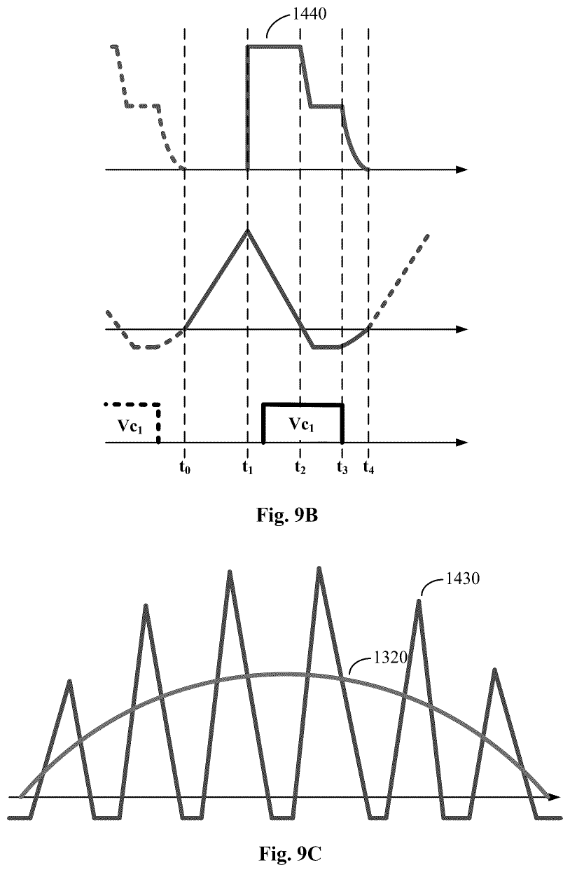

Between t2 and t3 as depicted in FIGS. 9A and 9B and 9C the negative magnetizing current is trapped in the MCPM (Magnetizing Current Preservation Module) wherein the amplitude of the negative magnetizing current remains constant if Vinj 1 is zero, or increases its negative amplitude if Vinj1 has a positive value. The negative amplitude current through Lc flows from Vo via M1 and parasitic capacitance across M2, and towards P (Phase), the current flows from N (Neutral) and via D2 and Co.

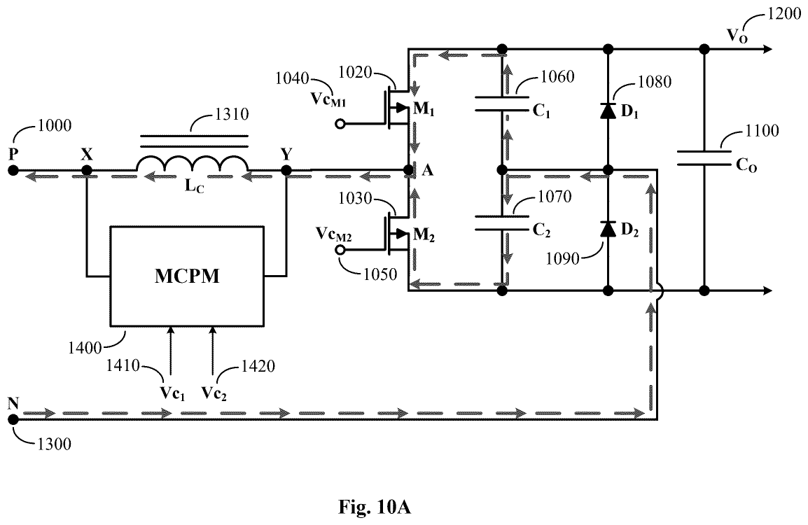

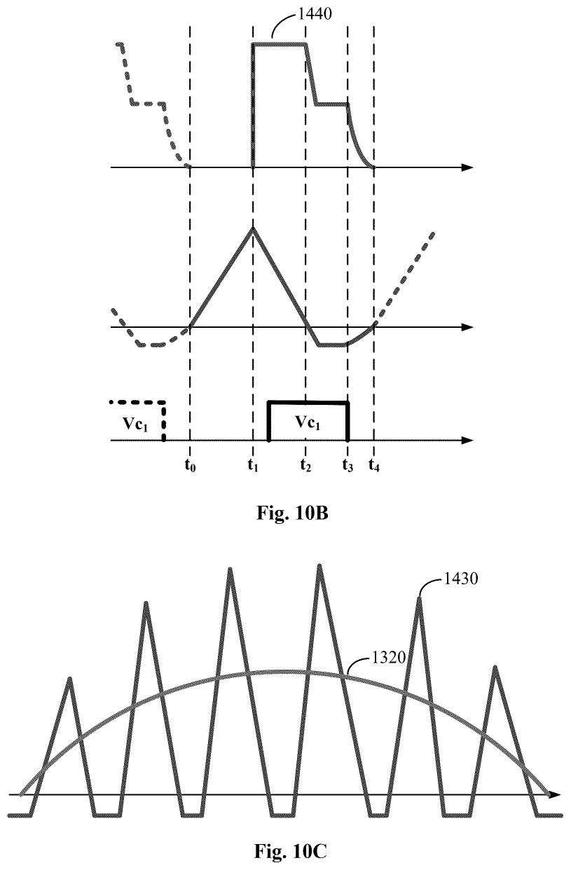

Between t3 and t4 as depicted in FIGS. 10A, 10B, and 10C, the current through Lc has a negative amplitude and flows on the path depicted in FIG. 10C. The negative amplitude current discharges the parasitic capacitance across the switching node A and creates zero voltage switching conditions for M2 at t4.

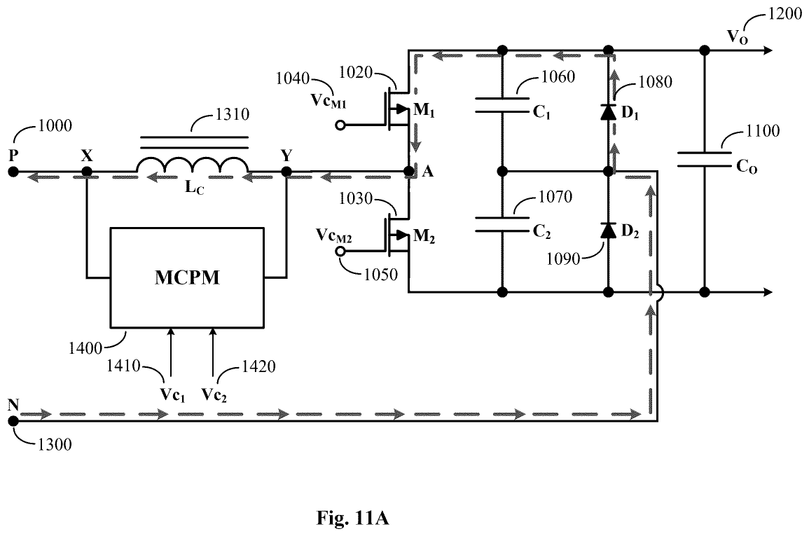

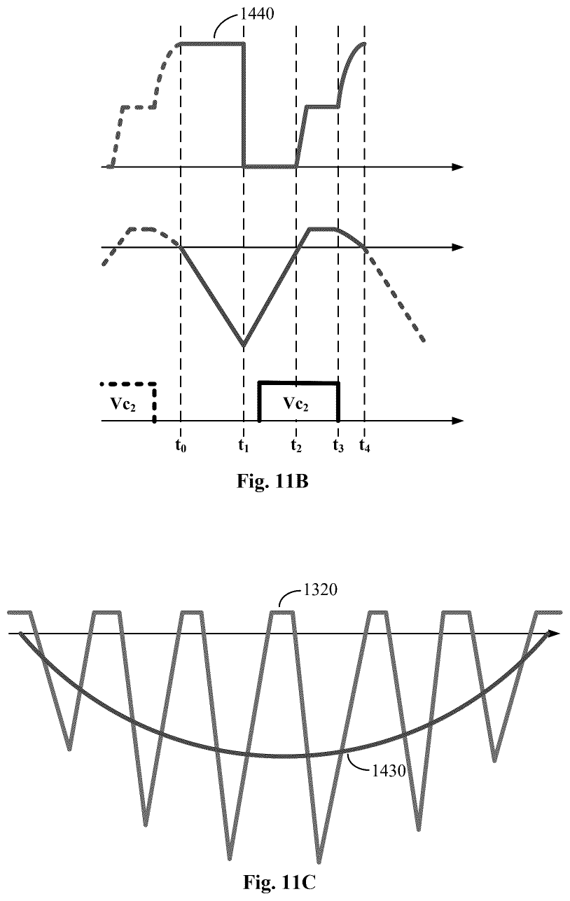

FIGS. 11A, 11B and 11C present the input line voltage when the polarity is negative, and it is also depicted the symbolic current via Lc.

From t0 to t1, the voltage in between P (Phase) and N (Neutral) has a negative polarity. As depicted, the current flows from N (Neutral) via D1 and M1 and further through Lc returning to P (Phase). The voltage in A is Vo and the current builds up from 0 to a negative peak amplitude as depicted.

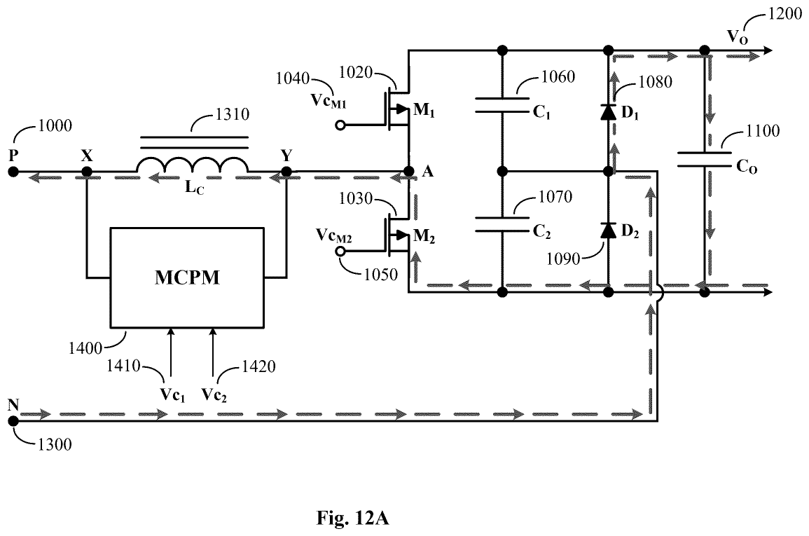

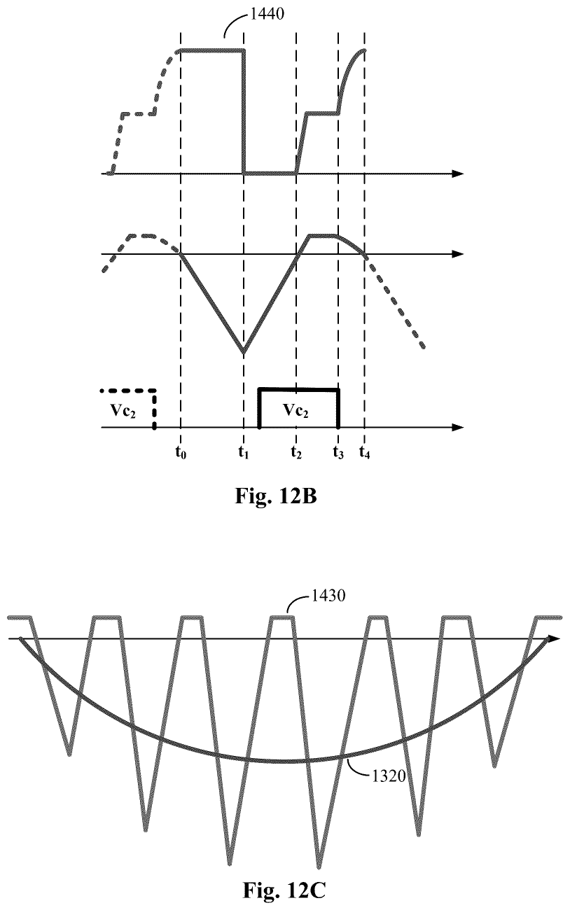

From t1 to t2 as depicted in FIGS. 12A, 12B and 12C the current flows from N (Neutral) via D1 and M1 and further through Lc returning to P (Phase). The voltage in A is 0 because M2 is turned on and the current amplitude decreases from the peak negative current to zero.

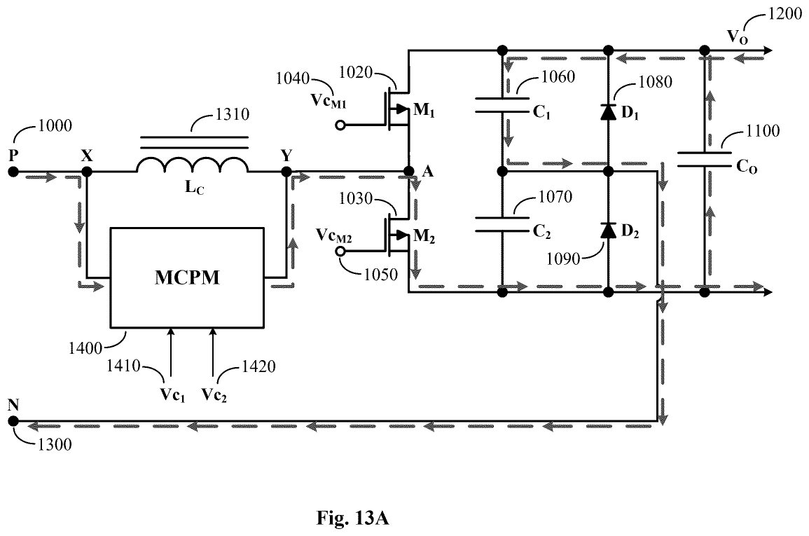

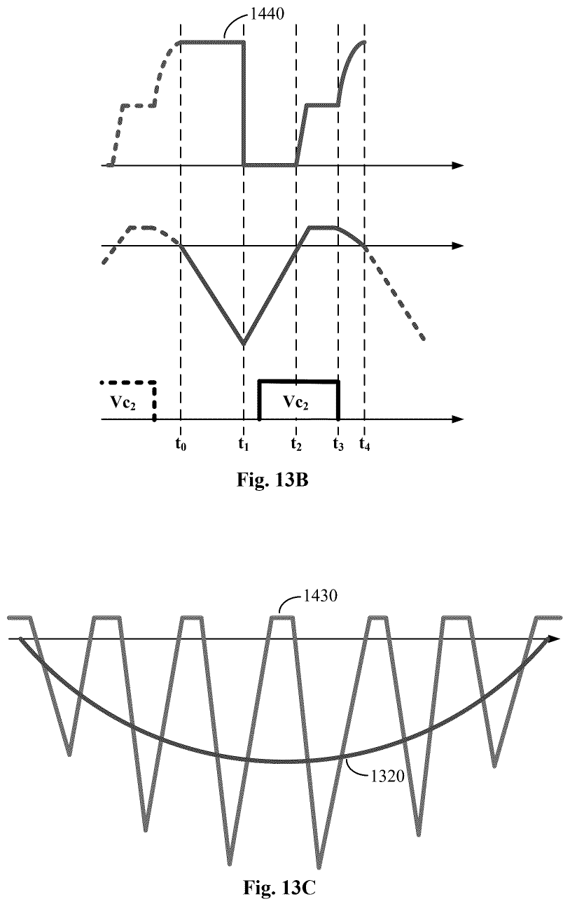

From t2 to t3 as depicted in FIGS. 13A, 13B and 13C the current is flowing through Lc and the MCPM module. If Vinj 2 from MCPM is zero, the amplitude of the positive polarity magnetizing current is constant, and if Vin2>0 then the amplitude of the positive polarity magnetizing current increases as is depicted in FIG. 12C.

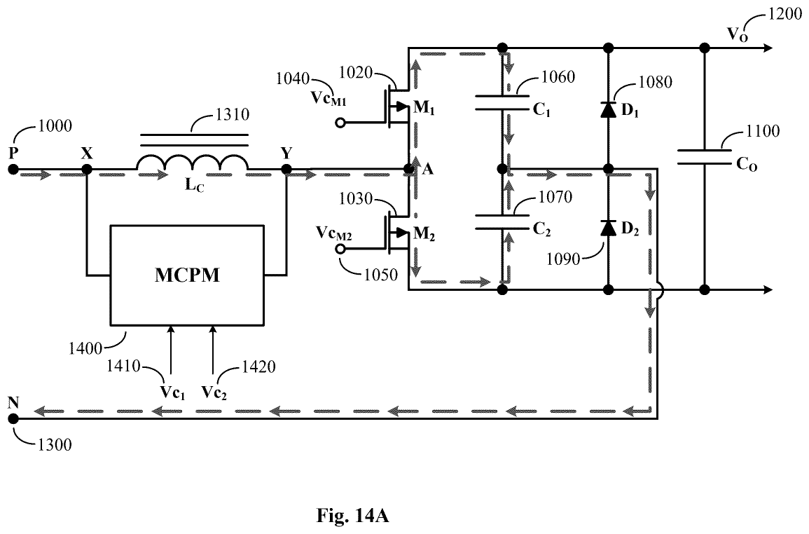

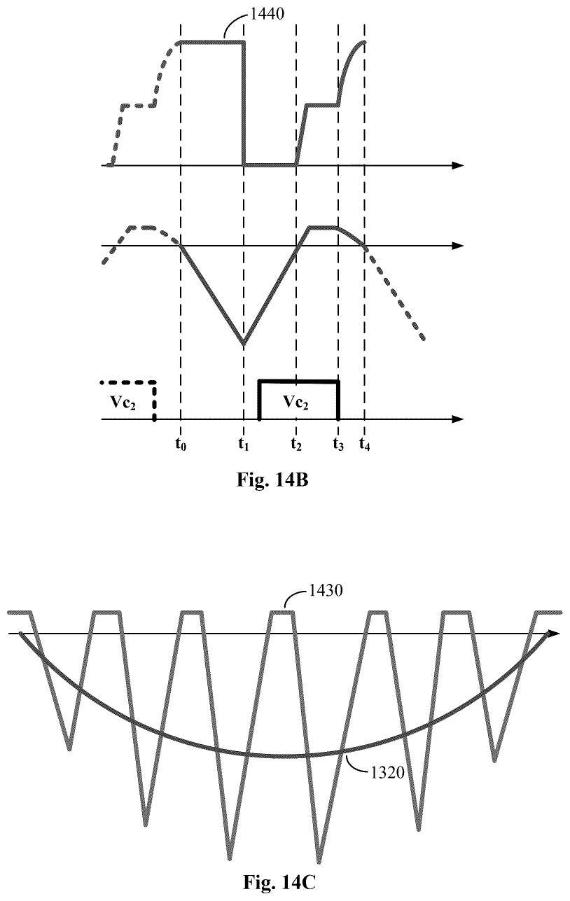

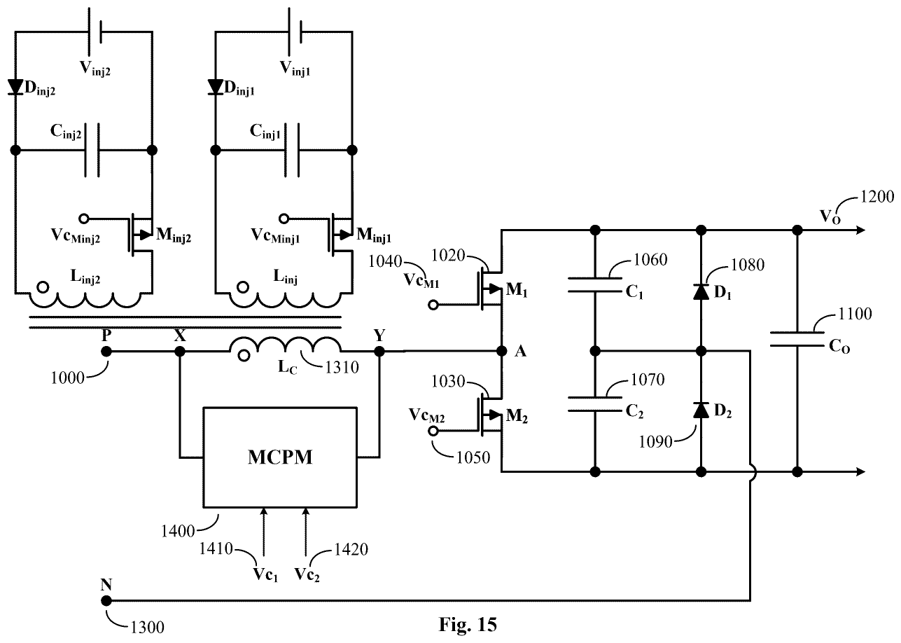

From t3 to t4 as depicted in FIGS. 14A,14B and 14C, the current flows from P (Phase) via Lc, and parasitic capacitances of M2 and M1. The magnetizing current amplitude decreases from the peak positive level to zero as depicted in FIG. 14B.

This solution is wherein the operation is done in discontinuous mode and by the use of MCPM module, zero voltage switching across all the switching elements can be achieved. Unlike the operation in boundary conditions, in this technology the frequency can be controlled in a much narrower range and also kept constant.

FIG. 15 depicts the Totem Pole bridgeless PFC using the MCPM module and in addition to that there are two current injection circuits formed by an auxiliary winding Linj1 and Linj2, a current injection switch Minj1 and Minj2, current injection capacitors, Cinj1 and Cinj2, two current injection diodes Dinj1 and Dinj2 and a voltage injection Vinj1 and Vinj2. This circuit injects a pulse of current prior M2 and M2 turn on to ensure that M1 and M2 turn on at zero voltage. There are two current injection circuits, one for positive alternance and one for the negative alternance. The current injection module also addresses zero voltage switching in continuous mode which may be a mode of operation. Using the MCPM module, the PFC circuit depicted in FIG. 7 can obtain zero voltage switching for M1 and M2 by operating in discontinuous mode and by the use of the current injection circuits depicted in FIG. 15, zero voltage switching for said M1 and M2 can be extended also for continuous mode operation.

A preferred embodiment is fully and clearly described above so as to enable one having skill in the art to understand, make, and use the same. Those skilled in the art will recognize that modifications may be made to the description above without departing from the spirit of the specification, and that some embodiments include only those elements and features described, or a subset thereof. To the extent that modifications do not depart from the spirit of the specification, they are intended to be included within the scope thereof.

What is claimed is:

1. A boost converter including:
an input voltage source;
an inductive element having a primary winding and a secondary winding;
a power switch connected to a termination of the primary winding;
a first rectifier having an anode and a cathode, wherein the anode is connected to the termination of the primary winding, and the cathode is connected to an output capacitor;
an output load connected across the output capacitor;
a current injection circuit formed by a current injection switch connected to a first termination of the secondary winding;
a current injection capacitor connected to a second termination of the secondary winding;
a current injection diode connected to the second termination of the secondary winding;
a storage capacitor connected to an anode of the current injection diode;
a slew rate capacitor connected to the anode of the first rectifier and to a node, wherein the node is connected to first and second signal rectifiers;
the first signal rectifier has an anode connected to the slew rate capacitor and a cathode connected to the storage capacitor; and
the second signal rectifier has a cathode connected to the slew rate capacitor.
